(19) United States
(12) Patent Application Publication
(10) Pub. No.: US 2016/0104052 A1
(43) Pub. Date: Apr. 14, 2016

(54) TEXT-BASED THUMBNAIL GENERATION

(71) Applicant: QUALCOMM Incorporated, San Diego, CA (US)

(72) Inventors: Kang Kim, Seoul (KR); Seungwoo Yoo, Sungnam (KR); Young-Ki Baik, Seoul (KR); Duck-Hoon Kim, Seoul (KR); Seok-Soo Hong, Seoul (KR)

(21) Appl. No.: 14/714,114

(22) Filed: May 15, 2015

Related U.S. Application Data
(60) Provisional application No. 62/062,670, filed on Oct. 10, 2014.

(51) Int. Cl. G06K 9/32; G06T 3/40; G06K 9/20

(52) U.S. Cl. CPC G06K 9/325; G06K 9/2081; G06T 3/40

(57) ABSTRACT

A method for displaying an image is disclosed. The method may be performed in an electronic device. Further, the method may detect at least one text region in the image and determine at least one text category associated with the at least one text region. Based on the at least one text region and the at least one text category, the method may generate at least one thumbnail from the image and display the at least one thumbnail.

### CROSS-REFERENCE TO RELATED APPLICATION(S)

This application claims the benefit of priority from U.S. Provisional Patent Application No. 62/062,670 entitled “TEXT-BASED THUMBNAIL IMAGE GENERATION,” filed on Oct. 10, 2014, the entire contents of which are incorporated herein by reference.

### FIELD OF THE DISCLOSURE

The present disclosure relates generally to generating a preview of an image, and more specifically, to generating a thumbnail for an image by using text region detection.

### DESCRIPTION OF RELATED ART

In recent years, the use of electronic devices such as smartphones, tablet computers, and the like has become widespread. Such electronic devices often include image processing capabilities for capturing and processing images. For example, conventional electronic devices may be equipped with one or more cameras for capturing images of a scene or objects and a camera application for managing and operating the cameras.

Conventional electronic devices are typically equipped with an application that can organize and display captured images via a display screen for a user. For example, when the application is activated, it may display one or more preview images of the captured images on the display screen. The user viewing the display screen may then select a preview image among the displayed preview images. In response to the user input, the application may display the captured image which is associated with the selected preview image.

The captured images may include a variety of objects such as buildings, people's faces, signs, and the like. However, as the number of preview images of the captured images that are displayed together on a display screen of an electronic device increases, a user may find it difficult to recognize or distinguish the objects in the preview images displayed on the electronic device due to a limited size of the display screen. In the case of preview images with text objects, displaying even a small number of such images may render the text objects in the images unrecognizable or unreadable.

### SUMMARY OF THE INVENTION

The present disclosure provides methods and apparatus for generating and displaying an image based on one or more text regions in the image.

According to one aspect of the present disclosure, a method for displaying an image is disclosed. The method may be performed in an electronic device. Further, the method may detect at least one text region in the image and determine at least one text category associated with the at least one text region. Based on the at least one text region and the at least one text category, the method may generate at least one thumbnail from the image and display the at least one thumbnail. This disclosure also describes an apparatus, a device, a system, a combination of means, and a computer-readable medium relating to this method.

According to another aspect of the present disclosure, an electronic device for displaying an image is disclosed. The electronic device may include a text region detection unit configured to detect at least one text region in the image; a text category determining unit configured to determine at least one text category associated with the at least one text region; a thumbnail generation unit configured to generate at least one thumbnail from the image based on the at least one text region and the at least one text category; and a thumbnail display unit configured to display the at least one thumbnail.

### BRIEF DESCRIPTION OF THE DRAWINGS

Embodiments of this disclosure will be understood with reference to the following detailed description, when read in conjunction with the accompanying drawings.

FIG. 1 illustrates an electronic device configured to display a plurality of thumbnails on a display screen, according to one embodiment of the present disclosure.

FIG. 2 illustrates a block diagram of an electronic device configured to generate and display a thumbnail of an original image based on a text region detected in the original image, according to one embodiment of the present disclosure.

FIG. 3 illustrates a detailed block diagram of a thumbnail management unit that includes a thumbnail generation module and a thumbnail display module, according to one embodiment of the present disclosure.

FIG. 4A illustrates an original image of a business signboard that includes a text region, according to one embodiment of the present disclosure.

FIG. 4B illustrates a thumbnail that is generated from the original image of the business signboard based on the text region, according to one embodiment of the present disclosure.

FIG. 5A illustrates an original image of a brochure that includes a plurality of text regions, according to one embodiment of the present disclosure.

FIG. 5B illustrates a thumbnail that is generated from the original image of the brochure based on a plurality of text regions, according to one embodiment of the present disclosure.

FIG. 6A illustrates an original image of a brochure that includes a text region having a plurality of sub-text regions, according to one embodiment of the present disclosure.

FIG. 6B illustrates a thumbnail that is generated from the original image of the brochure based on a plurality of sub-text regions, according to one embodiment of the present disclosure.

FIG. 7A illustrates an original image of a business card that includes a plurality of text regions, according to one embodiment of the present disclosure.

FIG. 7B illustrates a thumbnail that is generated from the original image of the business card based on a plurality of text categories, according to one embodiment of the present disclosure.

FIG. 8A illustrates an image of a letter envelope that includes a text region, according to one embodiment of the present disclosure.

FIG. 8B illustrates a thumbnail that is generated from the original image of the letter envelope by dividing the text region into a plurality of image portions, according to one embodiment of the present disclosure.

FIG. 9 is a flowchart of a method, performed in an electronic device, for generating a thumbnail of an original image, according to one embodiment of the present disclosure.

FIG. 10 is a flowchart of a method, performed in the electronic device, for displaying one or more thumbnails associated with a text category, according to one embodiment of the present disclosure.

FIG. 11 illustrates a block diagram of a mobile device in a wireless communication system in which the methods and apparatus of the present disclosure for generating and displaying a thumbnail from an original image may be implemented according to some embodiments.

### DETAILED DESCRIPTION

Reference will now be made in detail to various embodiments, examples of which are illustrated in the accompanying drawings. In the following detailed description, numerous specific details are set forth in order to provide a thorough understanding of the present subject matter. However, it will be apparent to one of ordinary skill in the art that the present subject matter may be practiced without these specific details. In other instances, well-known methods, procedures, systems, and components have not been described in detail so as not to unnecessarily obscure aspects of the various embodiments.

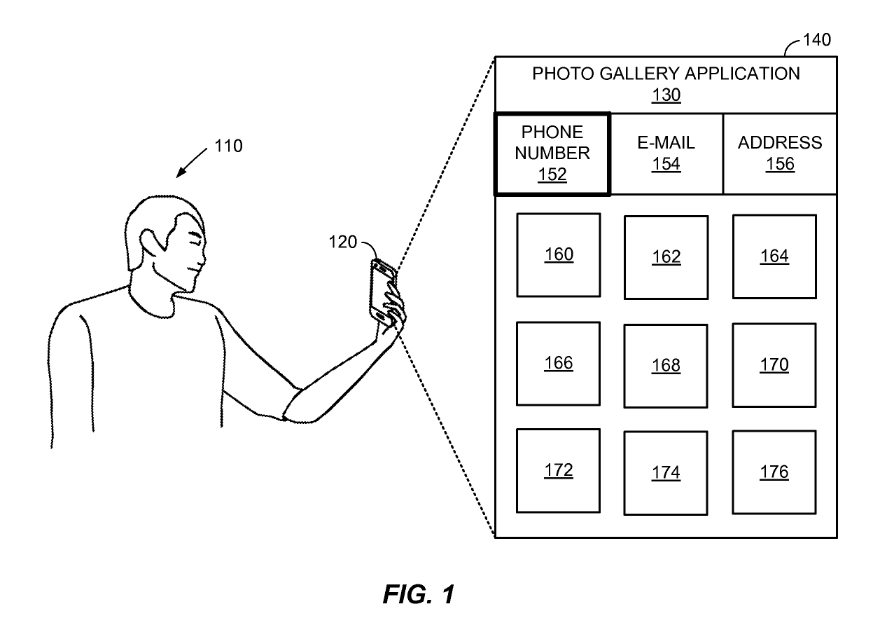

FIG. 1 illustrates an electronic device 120 configured to display a plurality of thumbnails 160 to 176 on a display screen 140, according to one embodiment of the present disclosure. In the illustrated embodiment, a user 110 may operate the electronic device 120 to execute a photo gallery application 130 which is adapted to organize and display one or more images of photographs, pictures, screenshots, video clips, or the like. The images may be captured by an image sensor (not shown) of the electronic device 120 and stored in a storage unit (not shown) of the electronic device 120. Alternatively or additionally, the images may be downloaded from an external server or another electronic device via a wired or wireless communication network and stored in the storage unit of the electronic device 120.

The photo gallery application 130, when executed, may display a plurality of preview images of a plurality of original images. Each of the preview images may be smaller in size than an associated original image. In some embodiments, the preview images may be displayed as the thumbnails 160 to 176. As used herein, the term “thumbnail” may refer to a smaller version or copy of an original image to indicate or represent the original image, and may include at least a portion of the original image. To generate a thumbnail, the portion of the original image may be scaled based on a size of the thumbnail. For example, a plurality of thumbnails of a plurality of images may be displayed on a screen to give a viewer a preview of the images to facilitate access to and searching of the images. In this case, if the viewer recognizes and selects one of the thumbnails (e.g., via an input unit such as a touch screen, a mouse, a keyboard, or the like), the image associated with the selected thumbnail may be displayed on the screen.

As illustrated in FIG. 1, the photo gallery application 130 may display a plurality of menu tabs 152, 154, and 156 indicating a plurality of text categories such as “PHONE NUMBER,” “E-MAIL,” and “ADDRESS,” respectively. For each of the text categories, one or more thumbnails may be generated from one or more original images based on text in the original images. According to one embodiment, the electronic device 120 may detect at least one text region in each of the original images and determine at least one text category (i.e., “PHONE NUMBER,” “E-MAIL,” or “ADDRESS”) that is associated with a detected text region. In this embodiment, text in such a detected text region may be recognized and the at least one text category may be determined based on the recognized text. At least one thumbnail for each original image may then be generated based on the detected text region and the determined text category.

In the case where an original image includes a phone number, the electronic device 120 may detect a text region in the original image that corresponds to the phone number. Additionally, the phone number may be recognized in the text region and the text category “PHONE NUMBER” may be determined to be associated with the text region based on the recognized phone number. A thumbnail for the original image may then be generated based on the text region corresponding to the phone number and the text category “PHONE NUMBER.” In this case, the thumbnail may be generated by selecting and enlarging an image of the phone number in the original image, for example, by cropping and scaling the text region in the original image that includes the phone number. Although the above case is described with the text category “PHONE NUMBER,” the electronic device 120 may also determine that a text region in an original image is associated with a different text category (e.g., “E-MAIL” or “ADDRESS”) and generate a thumbnail including the text region associated with the text category.

As shown in FIG. 1, when the photo gallery application 130 is executed, the menu tab 152 indicative of the text category “PHONE NUMBER” may be selected by a user (for example, via a touch input on the display screen 140) as indicated with a bolded line. In response, the electronic device 120 may display the thumbnails 160 to 176 generated from one or more original images that are determined to include text regions associated with the text category “PHONE NUMBER.” For example, some of the original images may include text indicative of mobile phone numbers, office phone numbers, home phone numbers, or the like. Text regions including the phone numbers in these original images may be enlarged and displayed as the thumbnails 160 to 176 so that the user 110 may easily read the phone numbers.

As used herein, the term “electronic device” may refer to any electronic device equipped with image processing capabilities and may further include image capturing capabilities and/or communication capabilities, such as a cellular phone, a smartphone, a wearable computer, a smart watch, smart glasses, a personal computer, a laptop computer, a tablet computer, a smart television, a digital camera, a gaming device, a multimedia player, etc. Accordingly, although the electronic device 120 is illustrated in FIG. 1 as a smartphone, it may be any suitable electronic device equipped with at least image processing capabilities. In addition, the electronic device 120 illustrated with the photo gallery application 130 may alternatively or additionally use any suitable applications that may organize, display, and/or edit one or more images and generate thumbnails for display in the manner as described above. Further, although the thumbnails 160 to 176 are illustrated as having the same size, thumbnails may be generated to have different sizes according to size or layout of text regions or text in the text regions.

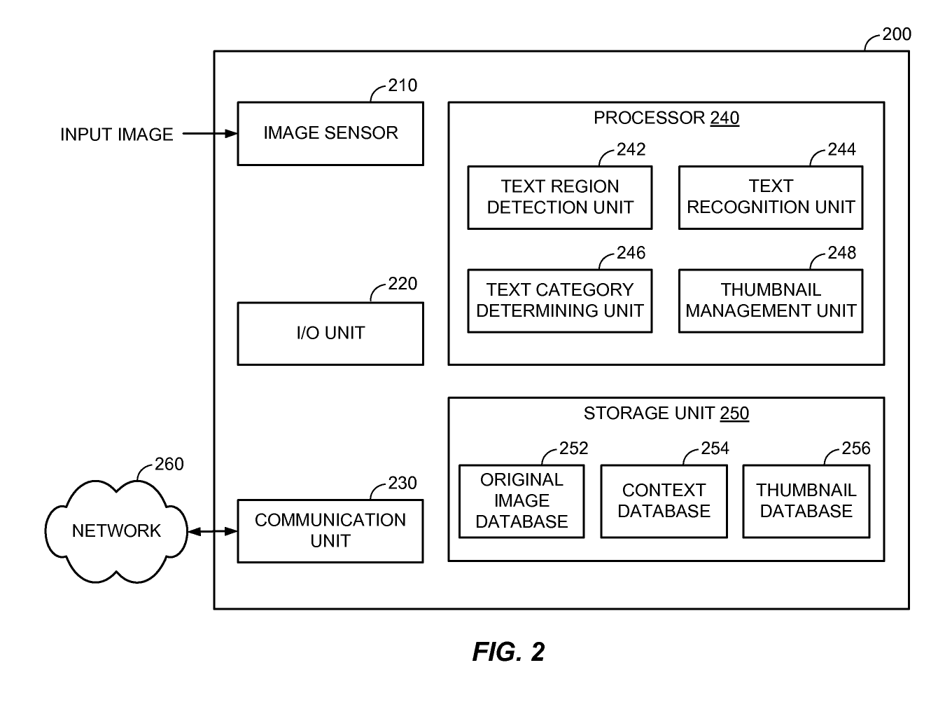

FIG. 2 illustrates a block diagram of an electronic device 200 configured to generate and display a thumbnail of an original image based on a text region detected in the original image, according to one embodiment of the present disclosure. The electronic device 200 may include an image sensor 210, an input/output (I/O) unit 220, a communication unit 230, a processor 240, and a storage unit 250. The electronic device 200 may be any suitable device equipped with image processing capabilities such as a cellular phone, a smartphone (e.g., the electronic device 120 in FIG. 1), a wearable computer, a smart watch, smart glasses, a laptop computer, a tablet computer, a smart television, a digital camera, a gaming device, a multimedia player, etc.

The image sensor 210 in the electronic device 200 may be configured to capture one or more input images as pictures, video clips, etc. The image sensor 210 may include one or more cameras or sensors that can be used to capture, sense, and/or detect an input image. In addition, the image sensor 210 may employ any suitable software and/or hardware for performing such functions. The captured images may be provided to the processor 240 for image processing and/or the storage unit 250 for storage. The storage unit 250 may be a remote or local storage, and may be implemented using any suitable storage or memory devices such as a random access memory (RAM), a read-only memory (ROM), an electrically erasable programmable read-only memory (EEPROM), a flash memory, an solid state drive (SSD), a cache memory, or the like.

In the electronic device 200, the storage unit 250 may store an original image database 252, a context database 254, and a thumbnail database 256. The original image database 252 may include one or more images captured via the image sensor 210 and may be accessed by the processor 240. Additionally or alternatively, the original image database 252 may include one or more images received from another electronic device (not shown) or an external server (not shown) through the communication unit 230 via an external network 260, or through the I/O unit 220. The images in the original image database 252 may be used in generating thumbnails, as will be described in more detail below. The electronic device 200 may communicate with another electronic device or an external server by using various data communication technologies such as Universal Serial Bus (USB), IEEE 1394 (FireWire), etc. via the I/O unit 220 or wireless or wired communication technologies such as Code Division Multiple Access (CDMA), Global System for Mobile Communications (GSM), Wideband CDMA (W-CDMA), Long Term Evolution (LTE), LTE-Advanced, LTE Direct, Wi-Fi, Wi-Fi Direct, Near-Field Communication (NFC), Bluetooth, Ethernet, etc. via the communication unit 230.

The context database 254 in the storage unit 250 may include a plurality of text categories such as “PHONE NUMBER,” “E-MAIL,” “ADDRESS,” “PERSON NAME,” “COMPANY NAME,” “DATE,” “TIME,” “URL,” or the like that may be indicative of context for text regions. The text categories may be predetermined or inputted via the I/O unit 220 from a user of the electronic device 200. Although the context database 254 is described with the above text categories, it may include any number of the above text categories and/or other text categories.

According to one embodiment, the context database 254 may include text information associated with a variety of text categories. The text information may include characters, numbers, symbols, words, phrases, names, formats associated with text categories, or the like that may be used to identify a text category for a text region. For example, text information on the text category “PHONE NUMBER” may include one or more numbers that may be separated by one or more symbols (e.g., “-” or “.”), country codes, area codes, words that may be indicative of phone numbers (e.g., “Phone,” “Mobile,” “Cellular,” “Office,” “Home,” etc.), or the like. On the other hand, text information on the text category “E-MAIL” may include one or more characters that may be separated by symbols (e.g., “@” and “.”), words that may be indicative of e-mail addresses (such as “E-mail,” “com,” “net,” etc.), or the like.

Additionally or alternatively, the context database 254 may include object information on a variety of objects that may include text. For example, business cards, pages of books or magazines, signboards, receipts, brochures, credit cards, personal or business checks, letter envelopes, or the like may be objects that include text. In this embodiment, the object information may include information on shapes, layouts, arrangements, templates, aspect ratios, colors, or the like of the objects. For example, object information on business cards may include a plurality of layouts or arrangements of company names, company logos, personal names, phone numbers, e-mail addresses, and street addresses, a plurality of aspect ratios of the business cards, or the like. In some embodiments, the object information may also include information on non-text objects such as corporate identities (CIs), company logos, or the like. For example, the information on non-text objects may include object features, colors, shapes, or the like of the non-text objects.

The processor 240 may include a text region detection unit 242, a text recognition unit 244, a text category determining unit 246, and a thumbnail management unit 248. The processor 240 may be any type of a processing unit configured to manage and operate the electronic device 200 and may include one or more processing cores. For example, the processor 240 may be implemented using an application processor (AP), a central processing unit (CPU), a micro-processor unit (MPU), a digital signal processor (DSP), or the like. The text region detection unit 242 in the processor 240 may be configured to receive an original image captured by the image sensor 210 or stored in the original image database 252. Additionally or alternatively, the text region detection unit 242 may receive an original image via the communication unit 230 or the I/O unit 220.

Upon receiving the original image, the text region detection unit 242 may detect at least one text region in the original image. According to one embodiment, one or more blobs of contiguous pixels may be determined for individual objects (e.g., characters, patterns, lines, or the like) in the original image. Based on the blobs of objects in the original image, one or more blobs having similar properties such as color, intensity, proximity, thickness, or the like may then be clustered into a blob cluster. For example, a plurality of blobs for characters having the same color and intensity and located in proximity of one another may be clustered into a blob cluster while a plurality of proximately located blobs for a non-text object having the same color and intensity may be clustered into another blob cluster. In some embodiments, each blob cluster may also be corrected for skew and filtered to remove artifacts. Additionally or alternatively, a blob cluster in color or gray scale may be converted into a black and white blob cluster.

To detect a text region, the text region detection unit 242 may determine whether each of the blob clusters includes text by using any suitable text region detection scheme such as an edge based method, a connected-component based method, a texture based method, or the like. In the above example, the blob cluster including the plurality of blobs for the characters may be determined to include text and detected as a text region. On the other hand, the blob cluster including the plurality of blobs for the non-text object may be determined not to include text and thus may be detected as a non-text region. In this manner, one or more text regions may be detected in the original image by clustering blobs of similar characteristics.

Upon detecting one or more text regions in the original image, the text category determining unit 246 may determine at least one text category associated with the detected text regions. In one embodiment, information on the detected text regions may be provided to the text recognition unit 244, which may perform a text recognition operation using any suitable text recognition method such as optical character recognition (OCR) or the like to recognize text in each of the text regions. Initially, each of characters in the text region, which may include one or more letters, numbers, or symbols, may be recognized Based on the recognized characters in each of the text regions, one or more character strings may be identified and recognized as words, phrases, or number sequences, which may be separated one or more symbols or blank spaces. For example, the recognized text for a text region may include one or more character strings such as a phone number, an e-mail address, a street address, a personal name, a title, a company name, a URL, a date, a time, or the like, as well as character strings (e.g., “Phone,” “E-mail,” “Address,” “Name,” “Date,” etc.) indicative of text categories. The recognized text for the detected text regions may be provided to the text category determining unit 246.

The text category determining unit 246 may determine one or more text categories associated with the text regions based on the recognized text for the text regions and the context database 254. According to one embodiment, the text category determining unit 246 may determine a text category for a text region based on the recognized text for the text region and the text information in the context database 254. For example, recognized text in a text region may include a word such as “Phone” and/or a string of numbers, which may be separated by one or more symbols (e.g., “-” or “.”) and may be indicative of a phone number. In this case, the text category determining unit 246 may determine whether the recognized word “Phone” matches any of the text categories (e.g., “PHONE NUMBER,” “E-MAIL,” “ADDRESS,” “PERSON NAME,” “COMPANY NAME,” “DATE,” “TIME,” “URL,” etc.) in the context database 254. Since the text information associated with the text category “PHONE NUMBER” includes words indicative of phone numbers (e.g., “Phone,” “Mobile,” “Office,” “Home,” etc.), the recognized word “Phone” may be determined to match the text category “PHONE NUMBER.” Thus, the text region including the recognized word “Phone” may be determined to be associated with the text category “PHONE NUMBER.”

Additionally or alternatively, the text category determining unit 246 may determine whether the recognized string of numbers matches any of the text categories in the context database 254. Since the text information associated with the text category “PHONE NUMBER” includes one or more numbers that may be separated by one or more symbols (e.g., “-” or “.”), country codes, area codes, or the like, the recognized string of numbers may be determined to match the text category “PHONE NUMBER.” Accordingly, the text region including the recognized string of numbers may be determined to be associated with the text category “PHONE NUMBER.”

In some embodiments, the text category determining unit 246 may determine a text category of a text region based on the object information in the context database 254. As described above, the object information may include information on shapes, layouts, arrangements, templates, aspect ratios, colors, or the like of objects such as business cards, pages of books or magazines, signboards, receipts, brochures, credit cards, personal or business checks, letter envelopes, CIs, company logos, or the like. The text category determining unit 246 may identify an object in an original image based on the object information, and determine a text category associated with a text region detected in the original image based on the identified object. For example, the text category determining unit 246 may identify an object in an original image as a business card based on the object information on business cards.

Additionally, a text region in the original image may include text “Toast,” which may indicate a name of a company rather than toasted bread. In this case, the text category determining unit 246 may determine that the text region including the text “Toast” is associated with the text category “COMPANY NAME” since the object in the original image has been identified as a business card. On the other hand, if the object in the original image has been identified as bread, the text region including the text “Toast” may be determined to be any other suitable category (e.g., “MENU” or the like). Although the text category determining unit 246 is described as determining text categories associated with detected text regions based on text recognized in text regions, the text categories may also be determined based on a shape, a layout, an arrangement, a pattern, a size, a width, a height, an aspect ratio, a color, an object, a context or the like of the text regions.

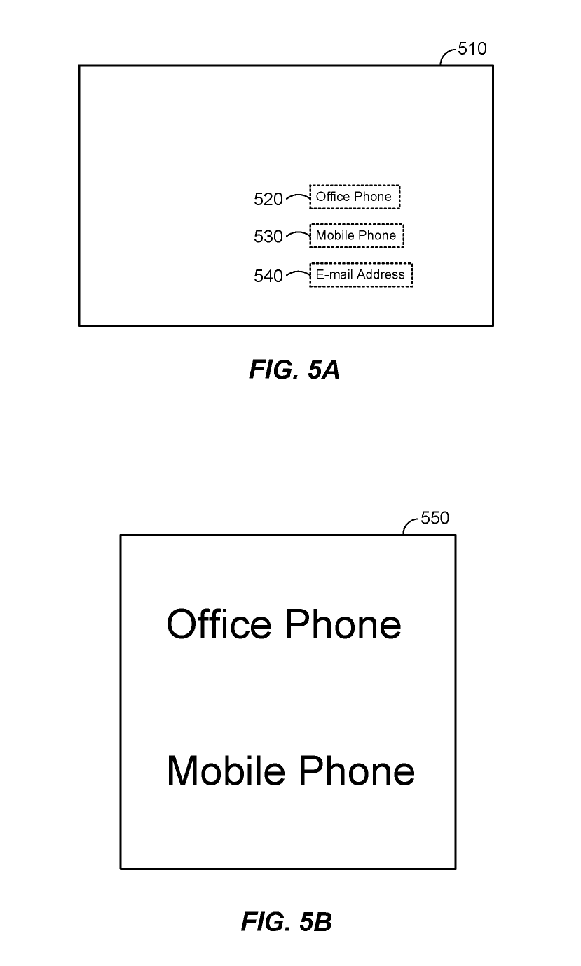

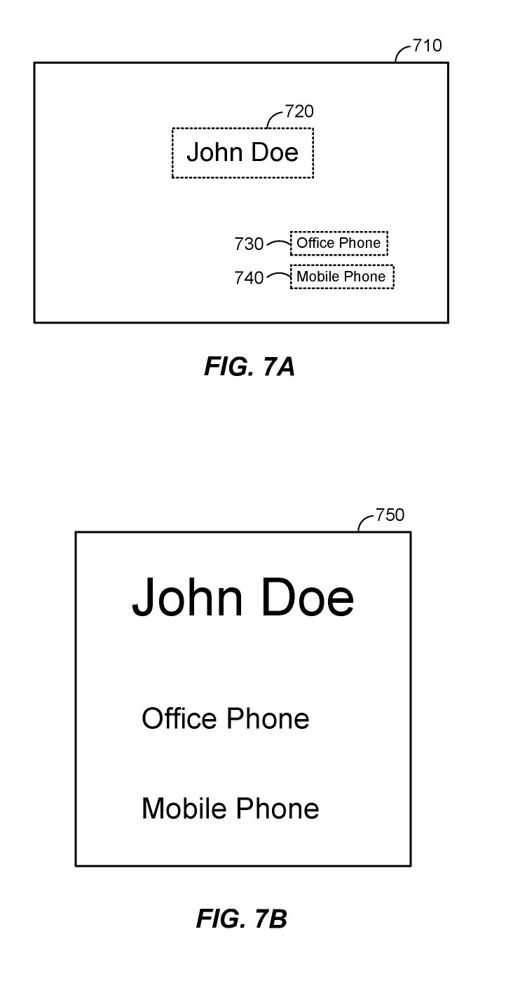

In some embodiments, a text category may be determined to be associated with a plurality of text regions in an original image, as will be described below in more detail with reference to FIGS. 5A and 5B. Additionally or alternatively, a plurality of text categories may be determined to be associated with a plurality of text regions in an original image, as will be described below in more detail with reference to FIGS. 7A and 7B. Further, a plurality of text categories may be determined to be associated with a text region in an original image.

Upon determining one or more text categories for one or more text regions in the original image, the thumbnail management unit 248 may generate one or more thumbnails associated with the original image based on the one or more text regions and the one or more text categories. In one embodiment, the thumbnail management unit 248 may generate one or more thumbnails, each of which may include at least one text region and may be associated with at least one text category. The thumbnails may be stored in the thumbnail database 256 of the storage unit 250. The thumbnail management unit 248 may also display the thumbnails in response to selecting a text category. For example, when a user selects a text category in the photo gallery application 130 (as illustrated in FIG. 1) via the I/O unit 220 (e.g., a touch screen, a keyboard, a mouse, etc.), thumbnails associated with the selected text category may be accessed from the thumbnail database 256 and displayed on the I/O unit 220 (e.g., a display screen).

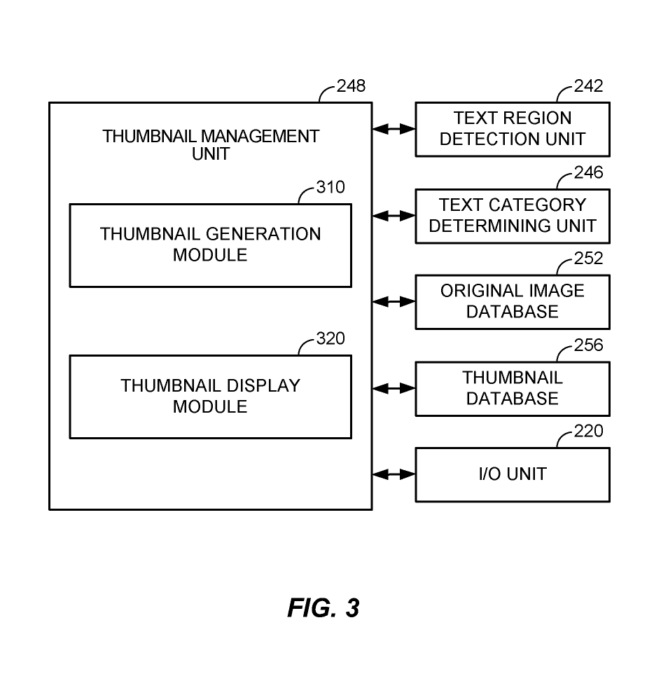

FIG. 3 illustrates a detailed block diagram of the thumbnail management unit 248 that includes a thumbnail generation module 310 and a thumbnail display module 320, according to one embodiment of the present disclosure. As illustrated, the thumbnail management unit 248 may communicate with the text region detection unit 242, the text category determining unit 246, the original image database 252, the thumbnail database 256, and the I/O unit 220, by providing and/or receiving any necessary data or information. Although the thumbnail generation module 310 and the thumbnail display module 320 are illustrated as being installed together in the thumbnail management unit 248, the thumbnail generation module 310 and the thumbnail display module 320 may be implemented separately in the processor 240.

The thumbnail generation module 310 may be configured to generate one or more thumbnails associated with one or more original images. Each thumbnail may include one or more text regions detected in an original image. According to one embodiment, the thumbnail generation module 310 may receive information and/or data on a text region (e.g., an image of the text region) in the original image from the text region detection unit 242. Additionally or alternatively, the thumbnail generation module 310 may receive location and shape information (e.g., coordinates) of the text region and retrieve the original image from the original image database 252. An image of the text region may then be obtained from the retrieved original image based on the location and shape information of the text region. The thumbnail generation module 310 may generate a thumbnail associated with the text region by scaling (e.g., enlarging) the image of the text region based on a predetermined size of a thumbnail.

In addition, the thumbnail generation module 310 may receive a text category associated with the text region from the text category determining unit 246 and may associate the generated thumbnail with the received text category (e.g., by tagging the thumbnail with the text category). In some embodiments, information and/or data indicative of the text category in any suitable format (e.g., metadata) may be generated and then added to information and/or data indicative of the thumbnail. The thumbnail tagged with the text category may be provided to and stored in the thumbnail database 256. The information and/or data indicative of the text category may be stored in the thumbnail database 256 together with the thumbnail.

According to some embodiments, a thumbnail may be generated from a plurality of text regions detected in an original image. In this case, the thumbnail generation module 310 may receive images for the plurality of text regions from the text region detection unit 242 and receive at least one text category associated with the text regions from the text category determining unit 246. Each of the images of the text regions may be scaled and the scaled text regions may be merged (or combined) to generate a thumbnail having a predetermined size. The thumbnail generation module 310 may tag the generated thumbnail with the at least one text category and store the thumbnail tagged with the text category in the thumbnail database 256. Additionally, in the operation of generating a thumbnail from one or more text regions, if it is determined that an image of a text region (or text in the text region) is slanted, curved, or skewed, the thumbnail generation module 310 may adjust the slanted, curved, or skewed text region (or the text) to be displayed horizontally in the generated thumbnail.

The thumbnail display module 320 may be configured to select, based on a text category, one or more thumbnails from the thumbnails stored in the thumbnail database 256 and display the selected thumbnails via the I/O unit 220 (e.g., a display screen, etc.). As described above, each thumbnail stored in the thumbnail database 256 may be associated with a text category. Thus, if a text category is selected using the photo gallery application 130 (as illustrated in FIG. 1) or any other suitable applications, for example, by a user input via the I/O unit 220, the thumbnail display module 320 may access the thumbnail database 256 to retrieve thumbnails associated with the selected text category. For example, if the selected text category is “PHONE NUMBER,” the thumbnail display module 320 may retrieve thumbnails associated with the text category “PHONE NUMBER,” which may include images of phone numbers, from the thumbnail database 256. The retrieved thumbnails may then be displayed on the I/O unit 220 for a viewer of the electronic device 200.

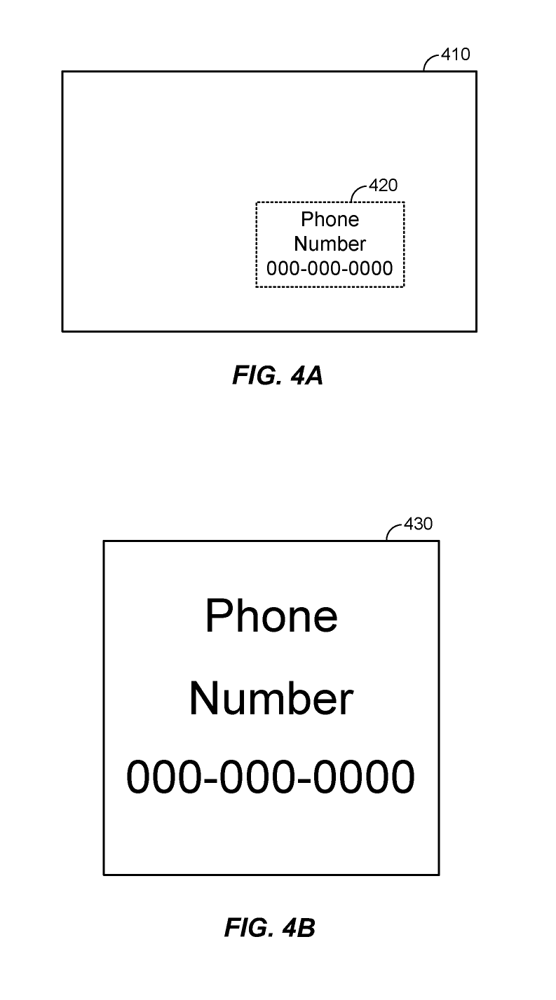

FIG. 4A illustrates an original image 410 of a business signboard that includes a text region 420, according to one embodiment of the present disclosure. The text region 420 in the original image 410 may include text “Phone Number 000-000-0000.” In this case, the text “Phone Number 000-000-0000” in the text region 420 may indicate a phone number of a shop associated with the business signboard.

The text region detection unit 242 in the processor 240 may receive the original image 410 from the image sensor 210 or the original image database 252 in the storage unit 250. Upon receiving the original image 410, the text region detection unit 242 may detect the text region 420 that includes the text “Phone Number 000-000-0000.” To detect the text region 420, the text region detection unit 242 may use any suitable text region detection scheme as described above with reference to FIG. 2.

In response to detecting the text region 420, the text category determining unit 246 may determine a text category associated with the text region 420. According to one embodiment, the text region 420 may be provided to the text recognition unit 244, which may recognize the text “Phone Number 000-000-0000” in the text region 420 by using any suitable text recognition scheme as described above with reference to FIG. 2. In this embodiment, each character in the text region 420, which may include letters, numbers, and symbols such as “P,” “h,” “o,” “n,” “e,” “N,” “u,” “m,” “b,” “e,” r,” “0,” “-” and the like may be recognized. In addition, one or more words or number strings such as “Phone,” “Number,” and “000-000-0000” may be recognized based on the recognized characters.

When the text “Phone Number 000-000-0000” is recognized by the text recognition unit 244, the text category determining unit 246 may determine the text category associated with the text region 420 based on the recognized text and the text information included in the context database 254 of the storage unit 250. In the illustrated embodiment, the text category “PHONE NUMBER” may be determined to be associated with the text region 420 based on the recognized word “Phone” or “Number” since the text information associated with the text category “PHONE NUMBER” may include such words indicative of phone numbers. Additionally or alternatively, the recognized number string “000-000-0000” may be used to determine the text category “PHONE NUMBER” to be associated with the text region 420 since the text information associated with the text category “PHONE NUMBER” may include number strings indicative of phone numbers. According to some embodiments, the text category associated with the text region 420 may be determined based on a shape, a layout, an arrangement, a pattern, a size, a width, a height, an aspect ratio, a color, a context, or the like of the text region 420.

FIG. 4B illustrates a thumbnail 430 that is generated from the original image 410 of the business signboard, according to one embodiment of the present disclosure. In response to determining the text category associated with the text region 420 by the text category determining unit 246, the thumbnail generation module 310 in the thumbnail management unit 248 may generate the thumbnail 430 based on the text region 420 and the associated text category. The thumbnail 430 may be generated to include the text region 420 and to be associated with the text category.

In the illustrated embodiment, since the text category for the text region 420 has been determined to be “PHONE NUMBER,” the thumbnail 430 may be generated to include the text region 420 (or the text , i.e., “PHONE NUMBER 000-000-0000,” associated with the text category) and may be tagged with the text category “PHONE NUMBER.” In one embodiment, the thumbnail generation module 310 may crop and enlarge a portion of the original image 410 that includes the text region 420 to generate the thumbnail 430. The thumbnail 430 tagged with the text category “PHONE NUMBER” may then be provided to and stored in the thumbnail database 256.

FIG. 5A illustrates an original image 510 of a brochure that includes a plurality of text regions 520, 530, and 540, according to one embodiment of the present disclosure. As illustrated, the text region 520 may include text “Office Phone,” the text region 530 may include text “Mobile Phone,” and the text region 540 may include text “E-mail Address.” In this embodiment, the text in the text regions 520, 530, and 540 may indicate contact information of a business or a person associated with the brochure. Although FIG. 5A illustrates the text “Office Phone” and “Mobile Phone” without a specified number and the text “E-mail Address” without a specified e-mail address, text in the brochure may include one or more character strings in any suitable format of phone numbers and/or e-mail addresses. The text region detection unit 242 in the processor 240 may detect the text regions 520, 530, and 540 including the text “Office Phone,” Mobile Phone,” and “E-mail address,” respectively.

In response to detecting the text regions 520, 530, and 540, the text category determining unit 246 may determine one or more text categories that are associated with the text regions 520, 530, and 540. According to one embodiment, the text regions 520, 530, and 540 may be provided to the text recognition unit 244, which may then recognize the text “Office Phone,” “Mobile Phone,” and “E-mail address” in the text regions 520, 530, and 540, respectively. Once the text is recognized in each of the text regions 520, 530, and 540, the text category determining unit 246 may determine a text category associated with each of the text regions 520, 530, and 540 based on the recognized text and the context database 254. In the illustrated embodiment, the text category “PHONE NUMBER” may be determined to be associated with the text region 520 based on the text “Office Phone” recognized in the text region 520. Similarly, the text category “PHONE NUMBER” may also be determined to be associated with the text region 530 based on the text “Mobile Phone” recognized in the text region 530. In addition, the text category “E-MAIL” may be determined to be associated with the text region 540 based on the text “E-mail Address” recognized in the text region 540.

FIG. 5B illustrates a thumbnail 550 that is generated from the original image 510 of the brochure, according to one embodiment of the present disclosure. The thumbnail generation module 310 in the thumbnail management unit 248 may generate at least one thumbnail based on the text regions 520, 530, and 540, and the text categories “PHONE NUMBER” associated with the text regions 520 and 530 and the text category “E-MAIL” associated with the text region 540. The thumbnail image may be generated to include two or more text regions, which are associated with a text category, among the text regions 520, 530, and 540.

In the illustrated embodiment, the thumbnail 550 may be generated to include the text regions 520 and 530 including the text “OFFICE PHONE” and “MOBILE PHONE,” which are associated with the text category “PHONE NUMBER.” According to one embodiment, the thumbnail generation module 310 may generate the thumbnail 550 by selecting (or cropping) the text regions 520 and 530 from the original image 510 and merging (or combining) the text regions 520 and 530. In another embodiment, the thumbnail generation module 310 may generate the thumbnail 550 by selecting (or cropping) and scaling (or enlarging) a portion (not shown) of the original image 510 that includes the text regions 520 and 530. Additionally, the thumbnail generation module 310 may associate (or tag) the thumbnail 550 with the text category “PHONE NUMBER.” Although FIG. 5B illustrates the thumbnail 550 associated with the text category “PHONE NUMBER,” the thumbnail generation module 310 may generate another thumbnail (not shown) associated with the other text category “E-MAIL.” In this case, the thumbnail may be generated by selecting and scaling the text region 540 associated with the text category “E-MAIL” (or a portion of the original image 510 that includes the text region 540).

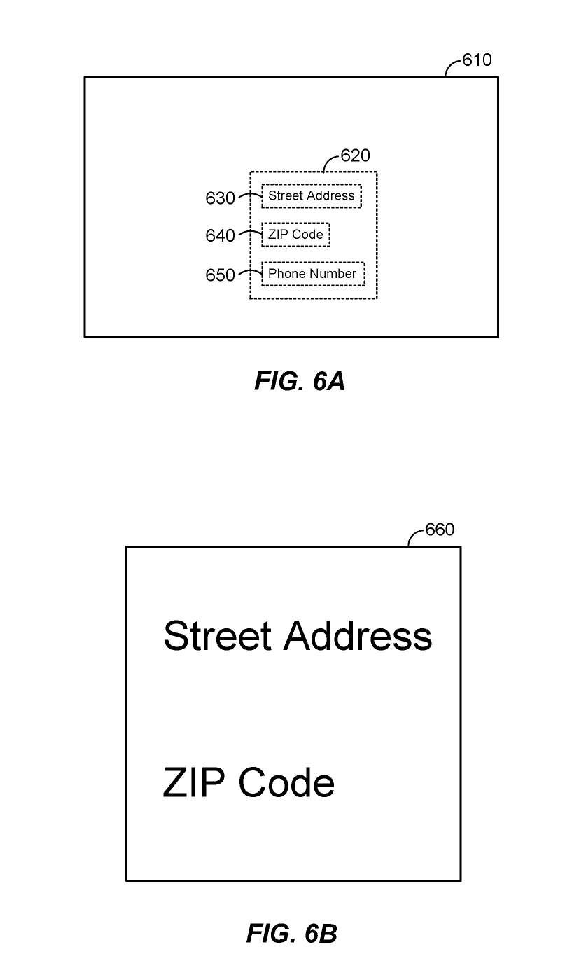

FIG. 6A illustrates an original image 610 of a brochure that includes a text region 620 having a plurality of sub-text regions 630, 640, and 650, according to one embodiment of the present disclosure. As illustrated, the text region 620 may include text “Street Address,” “ZIP Code,” and “Phone Number.” The text region detection unit 242 in the processor 240 may detect the text region 620 that includes the text “Street Address,” “ZIP Code,” and “Phone Number” by using any suitable text region detection scheme. Although FIG. 6A illustrates the text “Street Address,” “ZIP Code,” and “Phone Number” without a specified address, a specified ZIP code, and a specified phone number, text in the brochure may include one or more character strings in any suitable format of street addresses, ZIP codes, and/or phone numbers.

In this embodiment, a text region may include a plurality of text items (or text objects), each of which may have one or more character strings. The text items may be separated or identified based on arrangements, layouts, sizes, colors, blank spaces, meanings, contexts, or the like of the character strings. FIG. 6A illustrates three text items “Street Address,” “ZIP Code,” and “Phone Number” that are arranged separately in horizontal three lines. In this case, the text region detection unit 242 may detect the sub-text regions 630, 640, and 650, which include the text items “Street Address,” “ZIP Code,” and “Phone Number,” respectively, in the text region 620.

Once the sub-text regions 630, 640, and 650 are detected, the text category determining unit 246 may determine one or more text categories that are associated with the sub-text regions 630, 640, and 650. In the illustrated embodiment, the text category “ADDRESS” may be determined to be associated with each of the sub-text regions 630 and 640 based on the text which the text recognition unit 244 may recognize in the sub-text regions 630 and 640. On the other hand, the text category “PHONE NUMBER” may be determined to be associated with the sub-text region 650 based on the text which the text recognition unit 244 may recognize in the sub-text region 650.

FIG. 6B illustrates a thumbnail 660 that is generated from the original image 610 of the brochure, according to one embodiment of the present disclosure. The thumbnail generation module 310 in the thumbnail management unit 248 may generate at least one thumbnail based on the sub-text regions 630, 640, and 650, and the text category “ADDRESS” associated with the sub-text regions 630 and 640 and the text category “PHONE NUMBER” associated with the sub-text region 650. The thumbnail image may be generated to include two or more sub-text regions, which are associated with a text category, among the sub-text regions 630, 640, and 650.

In the illustrated embodiment, the thumbnail 660 may be generated to include the sub-text regions 640 and 650 including the text “Street Address” and “ZIP Code,” which are associated with the text category “ADDRESS.” Additionally, the thumbnail generation module 310 may associate (or tag) the thumbnail 660 with the text category “ADDRESS.” According to one embodiment, the thumbnail generation module 310 may generate the thumbnail 660 by selecting and merging the sub-text regions 630 and 640, or selecting and scaling a portion (not shown) of the original image 610 that includes the sub-text regions 630 and 640. Although FIG. 6B illustrates the thumbnail 660 associated with the text category “ADDRESS,” the thumbnail generation module 310 may generate another thumbnail (not shown) associated with the other text category “PHONE NUMBER.”

FIG. 7A illustrates an original image 710 of a business card that includes a plurality of text regions 720, 730, and 740, according to one embodiment of the present disclosure. As illustrated, the original image 710 may include text “John Doe,” which may indicate a person's name associated with the business card. Further, the original image 710 may include text “Office Phone” and “Mobile Phone,” which may indicate contact information of the person associated with the business card. Although FIG. 7A illustrates the text “Office Phone” and “Mobile Phone” without specified numbers, text in the business card may include one or more character (or number) strings in any suitable format of phone numbers.

The text region detection unit 242 in the processor 240 may detect the text regions 720, 730, and 740 including the text “John Doe,” “Office Phone,” and “Mobile Phone,” respectively. In response to detecting the text regions 720, 730, and 740, the text category determining unit 246 may determine one or more text categories that are associated with the text regions 720, 730, and 740. In the illustrated embodiment, the text category “PERSON NAME” may be determined to be associated with the text region 720 based on the text which the text recognition unit 244 may recognize in the text region 720. On the other hand, the text category “PHONE NUMBER” may be determined to be associated with each of the text regions 730 and 740 based on the text which the text recognition unit 244 may recognize in the text regions 730 and 740.

FIG. 7B illustrates a thumbnail 750 that is generated from the original image 710 of the business card, according to one embodiment of the present disclosure. The thumbnail generation module 310 in the thumbnail management unit 248 may generate at least one thumbnail based on the text regions 720, 730, and 740, and the text category “PERSON NAME” associated with the text region 720 and the text category “PHONE NUMBER” associated with the text regions 730 and 740. The thumbnail image may be generated to include two or more text regions that are associated with two or more different text categories.

In some embodiments, the context database 254 in the storage unit 250 may include text category information that associates a text category with one or more other text categories. For example, since a business card may include a person's name and contact information that may be associated with the person, the text category information may associate the text category “PERSON NAME” with the text category “PHONE NUMBER.” Thus, in the illustrated embodiment, the thumbnail 750 may be generated to include the text region 720 associated with the text category “PERSON NAME” and the text regions 730 and 740 associated with the text category “PHONE NUMBER” based on the text category information.

Additionally, the thumbnail generation module 310 may associate (or tag) the thumbnail 750 with either the text category “PERSON NAME” or the text category “PHONE NUMBER.” According to one embodiment, the thumbnail 750 may be associated with both of the text categories “PERSON NAME” and “PHONE NUMBER.” In this embodiment, the thumbnail display module 320 may display the thumbnail 750 via the I/O unit 220 in response to selecting any of the associated text categories “PERSON NAME” and “PHONE NUMBER.”

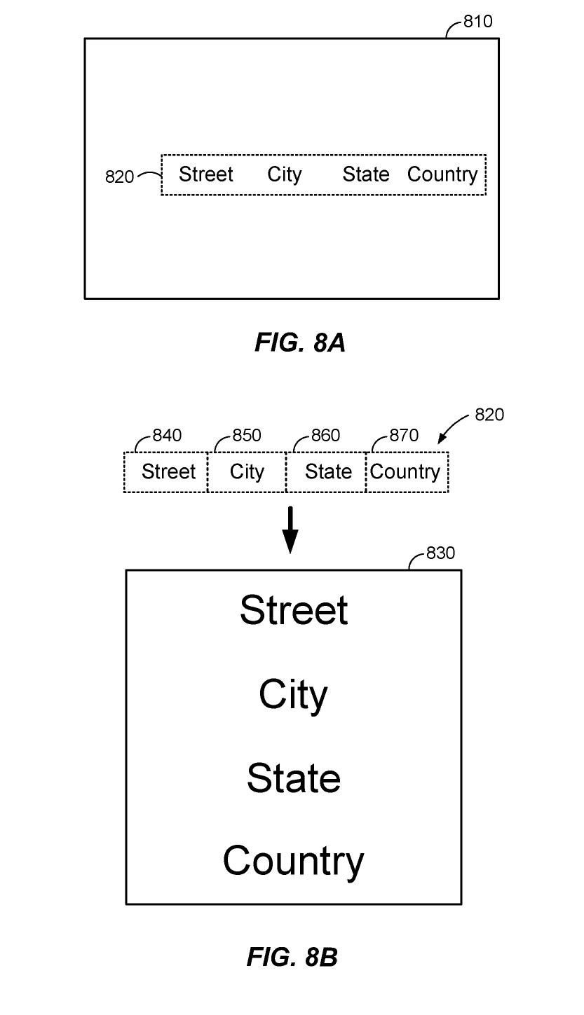

FIG. 8A illustrates an original image 810 of a letter envelope that includes a text region 820, according to one embodiment of the present disclosure. As illustrated, the text region 820 may include text “Street City State Country” that may indicate an address of a business or a person associated with the letter envelope. Although FIG. 8A illustrates the text “Street City State Country” without a specified street address, a specified city name, a specified state name, and a specified country name, text in the letter envelope may include one or more character strings in any suitable format of street addresses, city names, state names, and/or country names.

The text region detection unit 242 in the processor 240 may detect the text region 820 including the text “Street City State Country.” In response to detecting the text region 820, the text category determining unit 246 may determine at least one text category that is associated with the text region 820. In the illustrated embodiment, the text category “ADDRESS” may be determined to be associated with the text region 820 based on the text that the text recognition unit 244 may recognize in the text region 820.

FIG. 8B illustrates a thumbnail 830 that is generated from the original image 810 of the letter envelope, according to one embodiment of the present disclosure. The text region detection unit 242 may provide an image of the text region 820 to the thumbnail generation module 310 in the thumbnail management unit 248. Further, the text category determining unit may provide the text category “ADDRESS” associated with the text region 820 to the thumbnail generation module 310. In response, the thumbnail generation module 310 may generate the thumbnail 830.

In this embodiment, a variety of visual characteristics of the text region 820 such as a shape, an arrangement, a layout, a size, a width, a height, an aspect ratio, a length of text, or the like may be used in generating the thumbnail 830. For example, the thumbnail generation module 310 may divide the text region 820 into a plurality of image portions based on the visual characteristics of the text region 820 and generate the thumbnail 830 by scaling and combining the image portions. In the illustrated embodiment, since the width of the text region 820 is greater than the height of the text region 820 (or if the aspect ratio of the text region 820 is greater than a predetermined threshold ratio) as illustrated in FIG. 8A, the text region 820 may be divided into four image portions 840, 850, 860, and 870 in a lateral direction of the text region 820 such that the image portions 840, 850, 860, and 870 include character strings “Street,” “City,” “State,” and “Country,” respectively. The thumbnail generation module 310 may then generate the thumbnail 830 by combining (or merging) and scaling (or enlarging) the image portions 840, 850, 860, and 870. Additionally or alternatively, meanings of words or character strings in the text recognized from the text region 820 may be used in dividing the text region 820 and generating the thumbnail 830. The thumbnail may be tagged with the text category “ADDRESS” and stored in the thumbnail database 256.

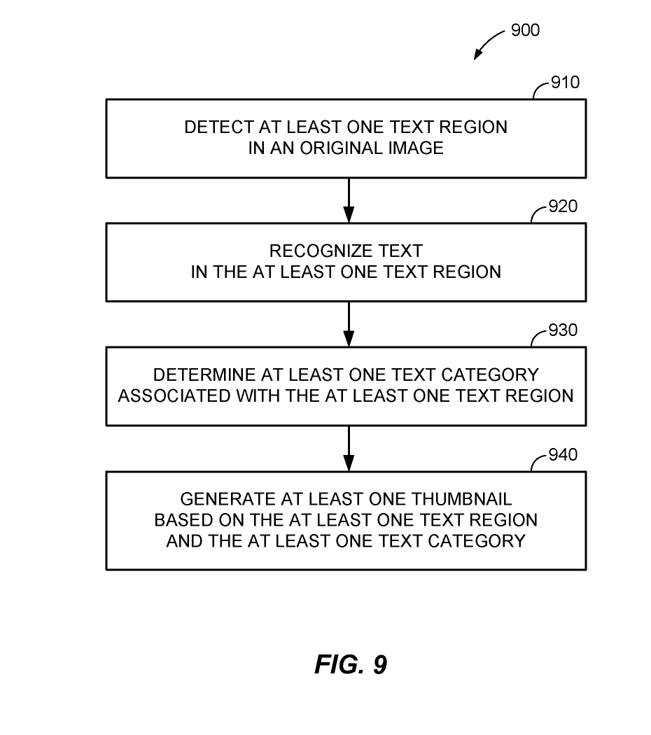

FIG. 9 is a flowchart of a method 900, performed in the electronic device 200, for generating a thumbnail of an original image, according to one embodiment of the present disclosure. The processor 240 may receive an original image from the image sensor 210 or the original image database 252 in the storage unit 250. The text region detection unit 242 in the processor 240 may detect at least one text region in the original image, at 910.

In response to detecting the at least one text region, the text recognition unit 244 in the processor 240 may recognize text in the at least one text region, at 920. One or more characters may be recognized from the text in the text region, and one or more words or character strings may be recognized from the recognized characters. Such recognized words or character strings may include words (e.g., “Phone,” “Mobile,” “Office,” etc.) that may be indicative of a text category (e.g., “PHONE NUMBER,” etc.).

Based on the detected text region and the recognized text, the text category determining unit 246 in the processor 240 may determine at least one text category (e.g., “PHONE NUMBER,” etc.) associated with the at least one text region, at 930. In one embodiment, a plurality of text categories may be determined to be associated with a plurality of text categories. Additionally or alternatively, a text category may be determined to be associated with a plurality of text regions. Although the illustrated embodiment determine the text category based on the text region and the text recognized in the text region, the text category determining unit 246 may determine the text category based on based on a shape, a layout, an arrangement, a pattern, a size, a width, a height, an aspect ratio, a color, an object, a context or the like of the text region.

The thumbnail generation module 310 in the thumbnail management unit 248 may generate at least one thumbnail based on the at least one text region and the at least one text category, at 940. The thumbnail may include one or more text regions. If a plurality of text categories is determined, a plurality of thumbnails associated with plurality of text categories may be generated. In one embodiment, a thumbnail may be generated to be associated with a text category. Alternatively or additionally, a thumbnail may be generated to be associated with a plurality of text categories. A thumbnail generated in the manner as described above may be tagged with one or more text categories and may be stored in the thumbnail database 256 of the storage unit 250.

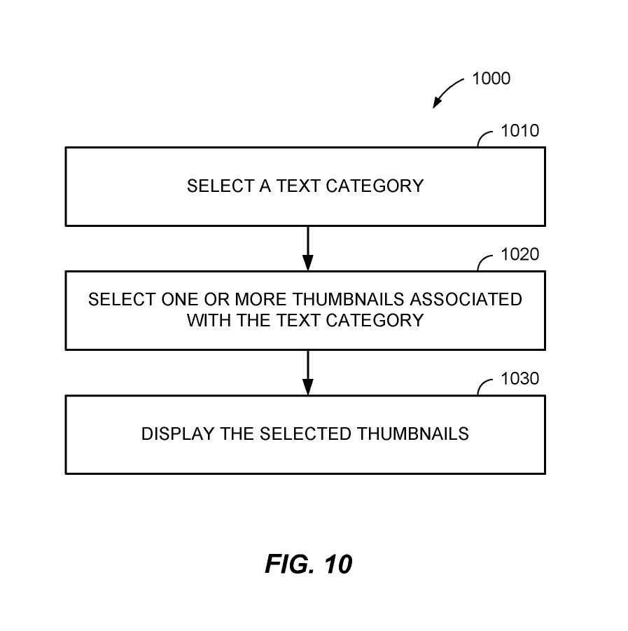

FIG. 10 is a flowchart of a method 1000, performed in the electronic device 200, for displaying one or more thumbnails associated with a text category, according to one embodiment of the present disclosure. As illustrated, the method 1000 may select a text category, at 1010. In some embodiments, the text category may be selected based on a user input that is indicative of a text category. For example, when the photo gallery application 130 (as illustrated in FIG. 1) is executed, a user may select one of the menu tabs 152, 154, and 156 indicating text categories such as “PHONE NUMBER,” “E-MAIL,” and “ADDRESS,” respectively, and a text category may be identified based on a selected menu tab.

In response to selecting the text category, the thumbnail display module 320 in the thumbnail management unit 248 may select one or more thumbnails, which are associated with the text category, among thumbnails stored in the thumbnail database 256, at 1020. For example, if the text category “PHONE NUMBER” is identified, thumbnail display module 320 may select one or more thumbnails, which are associated with the text category “PHONE NUMBER,” among the thumbnails stored in the thumbnail database 256. In addition, the selected thumbnails may be displayed, at 1030, via the I/O unit 220 (e.g., a display screen).

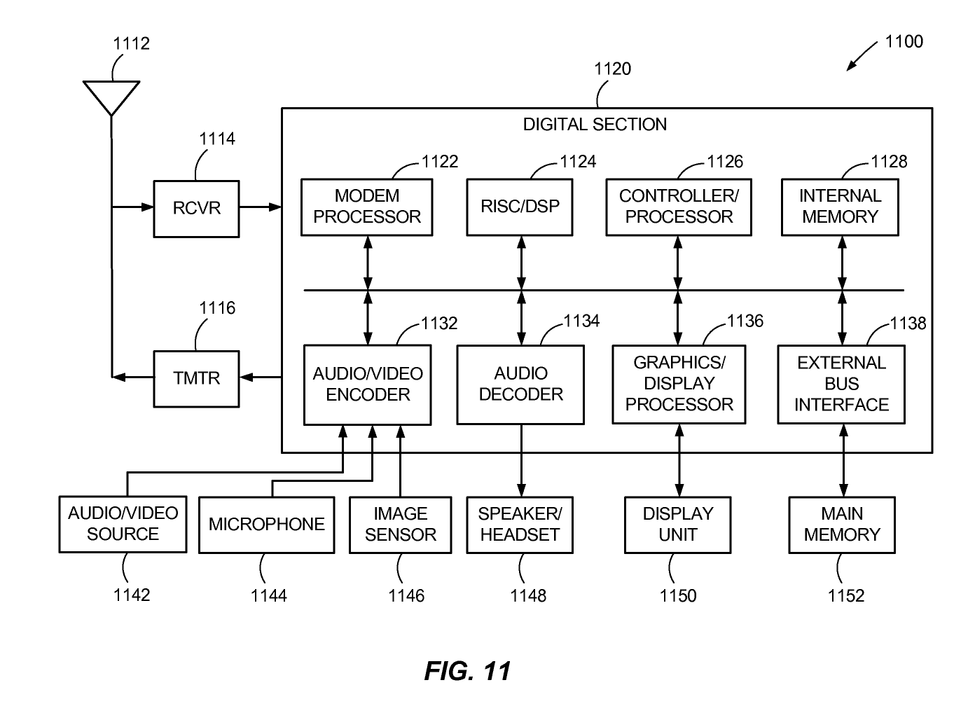

FIG. 11 illustrates a block diagram of a mobile device 1100 in a wireless communication system in which the methods and apparatus of the present disclosure for generating and displaying a thumbnail from an original image may be implemented according to some embodiments. The mobile device 1100 may be a cellular phone, a smartphone, a wearable computer, a smart watch, smart glasses, a tablet personal computer, a terminal, a handset, a personal digital assistant (PDA), a wireless modem, a cordless phone, a tablet, and so on. The wireless communication system may be a CDMA system, a GSM system, a W-CDMA system, a LTE system, a LTE Advanced system, and so on.

The mobile device 1100 may be capable of providing bidirectional communication via a receive path and a transmit path. On the receive path, signals transmitted by base stations may be received by an antenna 1112 and may be provided to a receiver (RCVR) 1114. The receiver 1114 may condition and digitize the received signal, and provide the conditioned and digitized digital signal to a digital section for further processing. On the transmit path, a transmitter (TMTR) 1116 may receive data to be transmitted from a digital section 1120, process and condition the data, and generate a modulated signal, which is transmitted via the antenna 1112 to the base stations. The receiver 1114 and the transmitter 1116 may be part of a transceiver that may support CDMA, GSM, W-CDMA, LTE, LTE Advanced, and so on.

The digital section 1120 may include various processing, interface, and memory units such as, for example, a modem processor 1122, a reduced instruction set computer/digital signal processor (RISC/DSP) 1124, a controller/processor 1126, an internal memory 1128, a generalized audio/video encoder 1132, a generalized audio decoder 1134, a graphics/display processor 1136, and an external bus interface (EBI) 1138. The modem processor 1122 may perform processing for data transmission and reception, e.g., encoding, modulation, demodulation, and decoding. The RISC/DSP 1124 may perform general and specialized processing for the mobile device 1100. The controller/processor 1126 may perform the operation of various processing and interface units within the digital section 1120. The internal memory 1128 may store data and/or instructions for various units within the digital section 1120.

The generalized audio/video encoder 1132 may perform encoding for input signals from an audio/video source 1142, a microphone 1144, an image sensor 1146, etc. The generalized audio decoder 1134 may perform decoding for coded audio data and may provide output signals to a speaker/headset 1148. The graphics/display processor 1136 may perform processing for graphics, videos, images, and texts, which may be presented to a display unit 1150. The EBI 1138 may facilitate transfer of data between the digital section 1120 and a main memory 1152.

The digital section 1120 may be implemented with one or more processors, DSPs, microprocessors, RISCs, etc. The digital section 1120 may also be fabricated on one or more application specific integrated circuits (ASICs) and/or some other type of integrated circuits (ICs).

In general, any device described herein may represent various types of devices, such as a wireless phone, a cellular phone, a laptop computer, a wireless multimedia device, a wireless communication personal computer (PC) card, a PDA, an external or internal modem, a device that communicates through a wireless channel, etc. A device may have various names, such as access terminal (AT), access unit, subscriber unit, mobile station, mobile device, mobile unit, mobile phone, mobile, remote station, remote terminal, remote unit, user device, user equipment, handheld device, etc. Any device described herein may have a memory for storing instructions and data, as well as hardware, software, firmware, or combinations thereof.

The techniques described herein may be implemented by various means. For example, these techniques may be implemented in hardware, firmware, software, or a combination thereof. Those of ordinary skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, the various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

For a hardware implementation, the processing units used to perform the techniques may be implemented within one or more ASICs, DSPs, digital signal processing devices (DSPDs), programmable logic devices (PLDs), field programmable gate arrays (FPGAs), processors, controllers, micro-controllers, microprocessors, electronic devices, other electronic units designed to perform the functions described herein, a computer, or a combination thereof.

Thus, the various illustrative logical blocks, modules, and circuits described in connection with the disclosure herein may be implemented or performed with a general-purpose processor, a DSP, an ASIC, a FPGA or other programmable logic device, discrete gate or transistor logic, discrete hardware components, or any combination thereof designed to perform the functions described herein. A general-purpose processor may be a microprocessor, but in the alternate, the processor may be any processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored at a computer-readable medium. Computer-readable media include both computer storage media and communication media including any medium that facilitates the transfer of a computer program from one place to another. A storage media may be any available media that can be accessed by a computer. By way of example, and not limited thereto, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media. For example, a computer-readable storage medium may be a non-transitory computer-readable storage device that includes instructions that are executable by a processor. Thus, a computer-readable storage medium may not be a signal.

The previous description of the disclosure is provided to enable a person skilled in the art to make or use the disclosure. Various modifications to the disclosure will be readily apparent to those skilled in the art, and the generic principles defined herein are applied to other variations without departing from the scope of the disclosure. Thus, the disclosure is not intended to be limited to the examples described herein but is to be accorded the widest scope consistent with the principles and novel features disclosed herein.

Although exemplary implementations are referred to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices may include PCs, network servers, and handheld devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be appreciated that the above identified modules or programs (i.e., sets of instructions) need not be implemented as separate software programs, procedures or modules, and thus various subsets of these modules may be combined or otherwise re-arranged in various embodiments.

### <Aspects of the Present Disclosure>

Hereinafter, some aspects of the present disclosure will be additionally stated.

(Example 1) According to an aspect of the present disclosure, there is provided a method for displaying an image, including detecting at least one text region in the image; determining at least one text category associated with the at least one text region; generating at least one thumbnail from the image based on the at least one text region and the at least one text category; and displaying the at least one thumbnail.

(Example 2) In the method of Example 1, the at least one thumbnail includes the at least one text region.

(Example 3) In the method of Example 1 or 2, the at least one text region includes a plurality of text regions, and generating the at least one thumbnail includes selecting, from the plurality of text regions, at least two text regions associated with a text category; and generating a thumbnail including the selected text regions.

(Example 4) In the method of any one of Examples 1 to 3, the at least one text region includes a plurality of text regions, and generating the at least one thumbnail includes selecting, from the plurality of text regions, at least two text regions associated with at least two text categories; and generating a thumbnail including the selected text regions.

(Example 5) In the method of any one of Examples 1 to 4, the at least two text categories include a first text category and a second text category, and the thumbnail includes a first text region associated with the first text category and a second text region associated with the second text category.

(Example 6) In the method of any one of Examples 1 to 5, determining the at least one text category includes recognizing text in the at least one text region; and determining the at least one text category based on the recognized text.

(Example 7) In the method of any one of Examples 1 to 6, the image includes a plurality of images, generating the at least one thumbnail includes generating a plurality of thumbnails from the plurality of images, and displaying the at least one thumbnail includes displaying the plurality of thumbnails.

(Example 8) In the method of any one of Examples 1 to 7, displaying the at least one thumbnail includes receiving an input indicative of a text category; selecting, from the at least one thumbnail, a thumbnail in response to the input; and displaying the selected thumbnail.

(Example 9) In the method of any one of Examples 1 to 8, generating the at least one thumbnail includes selecting, from the at least one text region, a text region based on a text category; and scaling the selected text region based on a size of a thumbnail.

(Example 10) According to another aspect of the present disclosure, there is provided an electronic device for displaying an image, including a text region detection unit configured to detect at least one text region in the image; a text category determining unit configured to determine at least one text category associated with the at least one text region; a thumbnail generation unit configured to generate at least one thumbnail from the image based on the at least one text region and the at least one text category; and a thumbnail display unit configured to display the at least one thumbnail.

(Example 11) In the electronic device of Example 10, the at least one thumbnail includes the at least one text region.

(Example 12) In the electronic device of Examples 10 or 11, the at least one text region includes a plurality of text regions, and the thumbnail generation unit is configured to select, from the plurality of text regions, at least two text regions associated with a text category; and generate a thumbnail including the selected text regions.

(Example 13) In the electronic device of any one of Examples 10 to 12, the at least one text region includes a plurality of text regions, and the thumbnail generation unit is configured to select, from the plurality of text regions, at least two text regions associated with at least two text categories; and generate a thumbnail including the selected text regions.

(Example 14) In the electronic device of any one of Examples 10 to 13, the at least two text categories include a first text category and a second text category, and the thumbnail generation unit is configured to generate the thumbnail to include a first text region associated with the first text category and a second text region associated with the second text category.

(Example 15) The electronic device of any one of Examples 10 to 14 further includes a text recognition unit configured to recognize text in the at least one text region. In this example, the text category determining unit is configured to determine the at least one text category based on the recognized text.

(Example 16) In the electronic device of any one of Examples 10 to 15, the image includes a plurality of images, the thumbnail generation unit is configured to generate a plurality of thumbnails from the plurality of images, and the thumbnail display unit is configured to display the plurality of thumbnails.

(Example 17) In the electronic device of any one of Examples 10 to 16, the thumbnail display unit is configured to select, from the at least one thumbnail, a thumbnail in response to an input indicative of a text category; and display the selected thumbnail.

(Example 18) In the electronic device of any one of Examples 10 to 17, the thumbnail generation unit is configured to select, from the at least one text region, a text region based on a text category; and scale the selected text region based on a size of a thumbnail.

(Example 19) According to still another aspect of the present disclosure, there is provided an electronic device for displaying an image, including means for detecting at least one text region in the image; means for determining at least one text category associated with the at least one text region; means for generating at least one thumbnail from the image based on the at least one text region and the at least one text category; and means for displaying the at least one thumbnail.

(Example 20) In the electronic device of Example 19, the at least one text region includes a plurality of text regions, and the means for generating the at least one thumbnail is configured to select, from the plurality of text regions, at least two text regions associated with a text category; and generate a thumbnail including the selected text regions.

(Example 21) In the electronic device of Example 19 or 20, the at least one text region includes a plurality of text regions, and the means for generating the at least one thumbnail is configured to select, from the plurality of text regions, at least two text regions associated with at least two text categories; and generate a thumbnail including the selected text regions.

(Example 22) The electronic device of any one of Examples 19 to 21 further includes means for recognizing text in the at least one text region. In this example, the means for determining the at least one text category is configured to determine the at least one text category based on the recognized text.

(Example 23) In the electronic device of any one of Examples 19 to 22, the image includes a plurality of images, the means for generating the at least one thumbnail is configured to generate a plurality of thumbnails from the plurality of images, and the means for displaying the at least one thumbnail is configured to display the plurality of thumbnails.

(Example 24) In the electronic device of any one of Examples 19 to 23, the means for displaying the at least one thumbnail is configured to select, from the at least one thumbnail, a thumbnail in response to an input indicative of a text category; and display the selected thumbnail.

(Example 25) According to still another aspect of the present disclosure, there is provided a non-transitory computer-readable storage medium including instructions causing at least a processor of an electronic device to perform operations of detecting at least one text region in an image; determining at least one text category associated with the at least one text region; generating at least one thumbnail from the image based on the at least one text region and the at least one text category; and displaying the at least one thumbnail.

(Example 26) In the non-transitory computer-readable storage medium of Example 25, the at least one text region includes a plurality of text regions, and generating the at least one thumbnail includes selecting, from the plurality of text regions, at least two text regions associated with a text category; and generating a thumbnail including the selected text regions.

(Example 27) In the non-transitory computer-readable storage medium of Example 25 or 26, the at least one text region includes a plurality of text regions, and generating the at least one thumbnail includes selecting, from the plurality of text regions, at least two text regions associated with at least two text categories; and generating a thumbnail including the selected text regions.

(Example 28) In the non-transitory computer-readable storage medium of any one of Examples 25 to 27, determining the at least one text category includes recognizing text in the at least one text region; and determining the at least one text category based on the recognized text.

(Example 29) In the non-transitory computer-readable storage medium of any one of Examples 25 to 28, the image includes a plurality of images, generating the at least one thumbnail includes generating a plurality of thumbnails from the plurality of images, and displaying the at least one thumbnail includes displaying the plurality of thumbnails.

(Example 30) In the non-transitory computer-readable storage medium of any one of Examples 25 to 29, displaying the at least one thumbnail includes receiving an input indicative of a text category; selecting, from the at least one thumbnail, a thumbnail in response to the input; and displaying the selected thumbnail.

What is claimed:

1. A method, performed by an electronic device, for displaying an image, comprising:
detecting at least one text region in the image;
determining at least one text category associated with the at least one text region;
generating at least one thumbnail from the image based on the at least one text region and the at least one text category; and
displaying the at least one thumbnail.

2. The method of claim 1, wherein the at least one thumbnail includes the at least one text region.

3. The method of claim 1, wherein the at least one text region includes a plurality of text regions, and
wherein generating the at least one thumbnail comprises:
selecting, from the plurality of text regions, at least two text regions associated with a text category; and
generating a thumbnail including the selected text regions.

4. The method of claim 1, wherein the at least one text region includes a plurality of text regions, and
wherein generating the at least one thumbnail comprises:
selecting, from the plurality of text regions, at least two text regions associated with at least two text categories; and
generating a thumbnail including the selected text regions.

5. The method of claim 4, wherein the at least two text categories include a first text category and a second text category, and
wherein the thumbnail includes a first text region associated with the first text category and a second text region associated with the second text category.

6. The method of claim 1, wherein determining the at least one text category comprises:
recognizing text in the at least one text region; and
determining the at least one text category based on the recognized text.

7. The method of claim 1, wherein the image includes a plurality of images,
wherein generating the at least one thumbnail comprises generating a plurality of thumbnails from the plurality of images, and
wherein displaying the at least one thumbnail comprises displaying the plurality of thumbnails.

8. The method of claim 1, wherein displaying the at least one thumbnail comprises:
receiving an input indicative of a text category;
selecting, from the at least one thumbnail, a thumbnail in response to the input; and
displaying the selected thumbnail.

9. The method of claim 1, wherein generating the at least one thumbnail comprises:
selecting, from the at least one text region, a text region based on a text category; and
scaling the selected text region based on a size of a thumbnail.

10. An electronic device for displaying an image, comprising:
a text region detection unit configured to detect at least one text region in the image;
a text category determining unit configured to determine at least one text category associated with the at least one text region;
a thumbnail generation unit configured to generate at least one thumbnail from the image based on the at least one text region and the at least one text category; and
a thumbnail display unit configured to display the at least one thumbnail.

11. The electronic device of claim 10, wherein the at least one thumbnail includes the at least one text region.

12. The electronic device of claim 10, wherein the at least one text region includes a plurality of text regions, and
wherein the thumbnail generation unit is configured to:
select, from the plurality of text regions, at least two text regions associated with a text category; and
generate a thumbnail including the selected text regions.

13. The electronic device of claim 10, wherein the at least one text region includes a plurality of text regions, and
wherein the thumbnail generation unit is configured to:
select, from the plurality of text regions, at least two text regions associated with at least two text categories; and
generate a thumbnail including the selected text regions.

14. The electronic device of claim 13, wherein the at least two text categories include a first text category and a second text category, and
wherein the thumbnail generation unit is configured to generate the thumbnail to include a first text region associated with the first text category and a second text region associated with the second text category.

15. The electronic device of claim 10, further comprising a text recognition unit configured to recognize text in the at least one text region,
wherein the text category determining unit is configured to determine the at least one text category based on the recognized text.

16. The electronic device of claim 10, wherein the image includes a plurality of images,
wherein the thumbnail generation unit is configured to generate a plurality of thumbnails from the plurality of images, and
wherein the thumbnail display unit is configured to display the plurality of thumbnails.

17. The electronic device of claim 10, wherein the thumbnail display unit is configured to:
select, from the at least one thumbnail, a thumbnail in response to an input indicative of a text category; and
display the selected thumbnail.

18. The electronic device of claim 10, wherein the thumbnail generation unit is configured to:
select, from the at least one text region, a text region based on a text category; and
scale the selected text region based on a size of a thumbnail.

19. An electronic device for displaying an image, comprising:
means for detecting at least one text region in the image;
means for determining at least one text category associated with the at least one text region;
means for generating at least one thumbnail from the image based on the at least one text region and the at least one text category; and
means for displaying the at least one thumbnail.

20. The electronic device of claim 19, wherein the at least one text region includes a plurality of text regions, and
wherein the means for generating the at least one thumbnail is configured to:
select, from the plurality of text regions, at least two text regions associated with a text category; and
generate a thumbnail including the selected text regions.

21. The electronic device of claim 19, wherein the at least one text region includes a plurality of text regions, and
wherein the means for generating the at least one thumbnail is configured to:
select, from the plurality of text regions, at least two text regions associated with at least two text categories; and
generate a thumbnail including the selected text regions.

22. The electronic device of claim 19, further comprising means for recognizing text in the at least one text region,
wherein the means for determining the at least one text category is configured to determine the at least one text category based on the recognized text.

23. The electronic device of claim 19, wherein the image includes a plurality of images,
wherein the means for generating the at least one thumbnail is configured to generate a plurality of thumbnails from the plurality of images, and
wherein the means for displaying the at least one thumbnail is configured to display the plurality of thumbnails.

24. The electronic device of claim 19, wherein the means for displaying the at least one thumbnail is configured to:
select, from the at least one thumbnail, a thumbnail in response to an input indicative of a text category; and
display the selected thumbnail.

25. A non-transitory computer-readable storage medium comprising instructions causing at least a processor of an electronic device to perform operations of:
detecting at least one text region in an image;
determining at least one text category associated with the at least one text region;
generating at least one thumbnail from the image based on the at least one text region and the at least one text category; and
displaying the at least one thumbnail.

26. The non-transitory computer-readable storage medium of claim 25, wherein the at least one text region includes a plurality of text regions, and
wherein generating the at least one thumbnail comprises:
selecting, from the plurality of text regions, at least two text regions associated with a text category; and
generating a thumbnail including the selected text regions.

27. The non-transitory computer-readable storage medium of claim 25, wherein the at least one text region includes a plurality of text regions, and
wherein generating the at least one thumbnail comprises:
selecting, from the plurality of text regions, at least two text regions associated with at least two text categories; and
generating a thumbnail including the selected text regions.

28. The non-transitory computer-readable storage medium of claim 25, wherein determining the at least one text category comprises:
recognizing text in the at least one text region; and
determining the at least one text category based on the recognized text.

29. The non-transitory computer-readable storage medium of claim 25, wherein the image includes a plurality of images,
wherein generating the at least one thumbnail comprises generating a plurality of thumbnails from the plurality of images, and
wherein displaying the at least one thumbnail comprises displaying the plurality of thumbnails.

30. The non-transitory computer-readable storage medium of claim 25, wherein displaying the at least one thumbnail comprises:
receiving an input indicative of a text category;
selecting, from the at least one thumbnail, a thumbnail in response to the input; and
displaying the selected thumbnail.
